(19) United States
(12) Patent Application Publication
(10) Pub. No.: US 2022/0349232 A1
(43) Pub. Date: Nov. 3, 2022

(54) ANTI-PINCH SYSTEM

(71) Applicant: NMB Technologies Corporation, Novi, MI (US)

(72) Inventors: Ohlan Silpachai, Newbury Park, CA (US); Christian Walter Voegerl, South Lyon, MI (US)

(21) Appl. No.: 17/302,359

(22) Filed: Apr. 30, 2021

(51) Int. Cl. E05F 15/46

(52) U.S. Cl. CPC E05F 15/46; E05Y 2900/531

(57) ABSTRACT

An anti-pinch system, apparatus and/or method. The system includes an elastomeric tubing with an internal cavity that is connected to a pressure sensor to measure pressure increases within the cavity in the event of a pressure rise. The tubing and pressure sensor can be configured for placement in a vehicle for detecting obstacles when the tubing is positioned between moving and fixed closing elements, such as obstacles positioned between a moving vehicle door and door perimeter cavity

### FIELD

The present invention is directed at an anti-pinch system, apparatus and/or method. The system includes an elastomeric tubing with an internal cavity that is connected to a pressure sensor to measure pressure increases within the cavity in the event of a pressure rise. The tubing and pressure sensor can be configured for placement in a vehicle for detecting obstacles positioned between moving closing elements and fixed closing elements, such as between a moving vehicle door and door perimeter cavity.

### BACKGROUND

Various anti-pinch systems have been reported to detect an obstacle in the path of a closing element of a vehicle, such as a vehicle door or window. Such systems are intended to interrupt the closing of such elements, when, e.g., an occupant's hand or finger may be caught between a moving door or window and the corresponding vehicle door frame or window frame. Anti-pinch systems have therefore become a safety feature within vehicles to mitigate the risk of harm to individual occupants.

Accordingly, a continuous need remains to provide relatively more responsive, reliable and less expensive anti-pinching systems for closing elements on a vehicle, which systems would also have the durability to maintain their performance over the lifetime of the vehicle in which they may be installed.

### SUMMARY

An anti-pinching system comprising one or a plurality of unsealed elastomeric tubing portions and at least one pressure sensor in communication with said one or more elastomeric tubing portions where said pressure sensor is configured to detect a pressure rise of 10 pascals or less over a period of time of 2.0 milliseconds or less.

An anti-pinching system for a vehicle door perimeter cavity configured to engage with a moving vehicle door. The system comprises one or a plurality of unsealed elastomeric tubing portions positioned between said moving vehicle door and vehicle door perimeter cavity and at least one pressure sensor in communication with the one or more elastomeric tubing portions where the pressure sensor is configured to detect a pressure rise of 10 pascals or less over a period of time of 2.0 milliseconds or less.

In method form, the present invention comprises a method for detecting a pinch condition for a movable closing element that engages into a cavity for the closing element, comprising measuring within one or a plurality of unsealed elastomeric tubing portions positioned between the moving closing element and the cavity, a pressure rise of 10 pascals or less over a period of time of 2.0 milliseconds or less and identifying a pinch condition as a consequence of such pressure rise.

### BRIEF DESCRIPTION OF THE DRAWINGS

Exemplary embodiments of the invention are explained in more detail with reference to the drawings, in which:

FIG. 1 provides a perspective view of the anti-pinch apparatus and system that is preferably configured for placement within a vehicular door frame.

FIG. 2 provides a cross-sectional view of the tubing portion and identifies the pressure sensor and controller.

### DETAILED DESCRIPTION

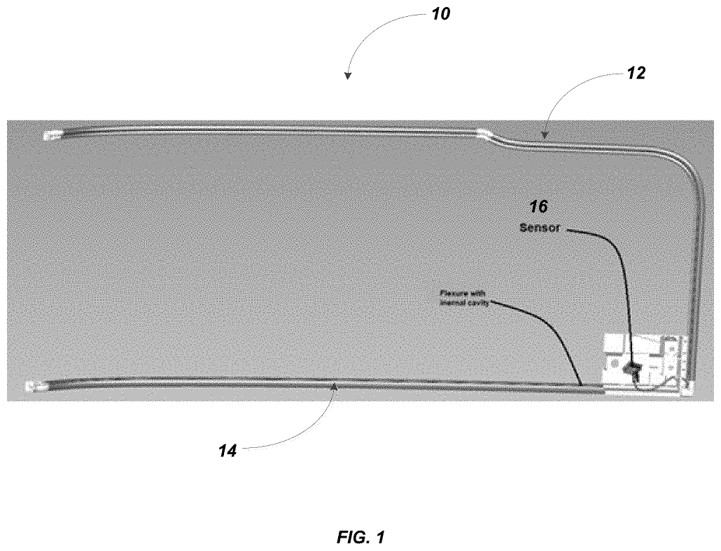

FIG. 1 provides a perspective view of the anti-pinch apparatus and system that is preferably configured for placement within a vehicular door frame. However, it should be appreciated that while the apparatus and system is preferably targeted for use in a vehicle door frame, the apparatus and system disclosed herein may be employed in any structure where closing elements may be present such as in vehicles and/or buildings. For example, the present invention may be employed wherever doors and windows are involved which have a movable closing element that ultimately engages with a support frame. Accordingly, with respect to vehicles, the present invention may preferably be employed in windows, doors including sliding doors found on mini-van type vehicles, trunk doors and/or tailgates. Moreover, the present invention may be preferably employed in both autonomous and non-autonomous vehicles, or on any door/window where opening/closing is automated or manual.

As therefore shown in FIG. 1, the anti-pinch apparatus 10 and system preferably includes at least one elastomeric tubing portions 12 and 14 that have an internal cavity and which can undergo flexure (reduction in the size of the internal cavity). The one or more tubing portions are in communication with a pressure sensor 16, which will be described in more detail herein. The tubing portions 12 and 14 may therefore be preferably positioned within the perimeter door cavity of a vehicle that engages with a moving (opening and closing) vehicle door portion. The vehicle perimeter door cavity is understood as the cavity opening for which the moving door is positioned and the one or more elastomeric tubing portions herein also provide a seal as between the moving door portion and door perimeter cavity when the moving vehicle door is in its closed position.

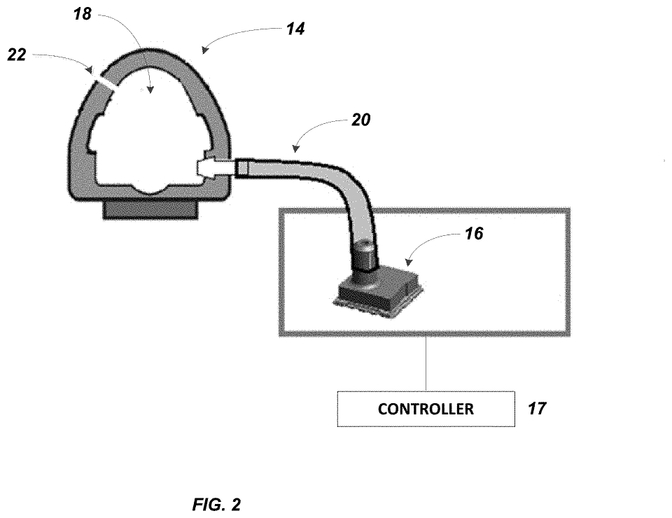

FIG. 2 provides a cross-sectional view of the tubing portion 14. As can be seen, the tubing portion 14 defines a cavity 18 that would preferably run along the length of the tube. In addition, the cavity is preferably connected by a separate tube 20 to the pressure sensor 16 which is in communication with a controller 17. The cavity may preferably have a hydraulic diameter in the range of 0.1 inch to 1.0 inches, more preferably in the range of 0.4 inch to 0.6 inch. Reference to hydraulic diameter Dh is calculated at 4 times the flow area “A” of the cavity divided by the wetted perimeter “P” of the cavity, accordingly Dh=4 A/P. The length of the one or more tubing portions 12 or 14 may preferably fall in the range of 30.0 inches to 50.0 inches, more preferably 35 inches to 45 inches. The wall thickness of the tubing may preferably be in the range of 0.1 inch to 0.3 inch, more preferably 0.10 inch to 0.15 inch. The tubing portion itself may assume a variety of geometrical forms, and preferably presents as a round, oval, ovoid (resembling an egg-shape), oblong or D-ring type shape.

Preferably, the elastomeric tubing portion 14 is sourced from a polymeric material that is capable of repeated flexing where the flexing will cause a reduction in the volume of the cavity 18 and a sufficient pressure change within the tubing to trigger a pressure rise over a selected period of time. Such pressure rise is then detected by the pressure sensor 16. Preferably, the polymeric material may therefore comprise a thermoplastic or thermoset type (crosslinked) polymer. One preferred example includes ethylene-propylene-diene monomer (EPDM) elastomer, which amounts to a copolymer of ethylene and propylene with a selected amount of polymerized diene monomer, which polymerized diene monomer can then facilitate cross-linking reactions. EPDM elastomers herein preferably have a Shore A Hardness in the range of 40-90, an ultimate tensile strength of about 2000 psi to 3000 psi and an elongation at break of about 500% to 600%. Other preferred polymers for use as the elastomeric tubing portion include polyurethanes, polyesters, polsiloxanes, fluroelastomers, flurosilicone elastomers, and styrene-butadiene elastomers. In the case of fluroelastomers, particularly preferred elastomers include copolymers of hexafluoropropylene (HFP) and vinylidene fluoride (VDF) or terpolymers of tetrafluoroethylene (TFE), vinylidene fluoride (VDF) and hexafluropropylene (HFP), some of what are sold under the tradename VITON®.

As illustrated in FIG. 2, the cavity 18 does not require sealing. The cavity may therefore have one or more vent openings 22. However, the number of vent hole openings and their size are such that upon compression of the elastomeric tubing portion, and reduction in the volume of cavity 18, a relatively low but still detectable pressure rise of, e.g., 10.0 Pascal (Pa) or less may be detected by pressure sensor 16. Accordingly, it is contemplated that the size of the vent openings that may be tolerated are those openings that have an opening diameter in the range of 0.06 inch or less or in the range of 0.01 inch to 0.06 inch.

Expanding upon the above, the one or more elastomeric tubing portions 12 or 14 preferably have a wall thickness and a cavity diameter that is able to respond to a pinching event and pressure change (e.g., upward pressure change or spike) within the tubing that is capable of detection by pressure sensor 16. In addition, the elastomeric tubing is also one that can preferably provide the requisite elastomeric characteristics required by an OEM to serve as a seal in, e.g., the perimeter door frame of the vehicle.

While FIG. 1 illustrates the use of two tubing portions connected to sensor 16, it should also be appreciated that in the broad context of the present invention, that one may utilize a single elastomeric tubing portion connected to a single sensor. Alternatively, one may include a plurality of elastomeric tubing portions 12 along with a plurality of sensors 16 to accommodate the need to surround the perimeter of a given vehicle door cavity. Accordingly, it is contemplated that one may use, for a given perimeter region that requires sealing, 2-10 tubing portions along with 2-10 sensors.

The pressure sensor 16 herein is preferably one that as noted, can detect a pressure rise of 10.0 Pa or less. More preferably, the sensor is one that can detect a pressure rise of 10.0 Pa or less that may occur over a period of time of 2.0 milliseconds or less. The pressure sensor herein is also one that is preferably contemplated to detect a pressure rise of 0.05 Pa to 10.0 Pa over a time period of 0.1 milliseconds to 2.0 milliseconds. Preferably, the pressure sensor for use herein can include the MMR920 or MMR921 pressure sensor that is available from MinebeaMitsumi.

As also illustrated in FIG. 2, the pressure sensor 16 is preferably in communication with a controller 17, which can respond to the observed pressure increase in several ways. For example, in a situation where one may be utilizing an automatically closing vehicle door, the pressure sensor may now detect a pinch, which may be the result of an occupant's hand or finger being interposed between the door opening perimeter and the closing door structure. The pressure sensor, as noted, can now detect a pressure rise of 10.0 Pa or less over a period of time of 2.0 milliseconds or less that takes place within the one or more elastomeric tubing portions and report such event to the controller 17. The controller 17 may then be in communication with the vehicle's electrical system and command the door to stop closing and/or to immediately return the moving door to an open or safe position. A similar sequence of events is now also contemplated for a vehicle window or any other closing elements that may be present in a given vehicle model where an occupant's appendage (arm, leg, finger) may be trapped. In addition, the system here is contemplated to provide safety for animals, where a tail or other appendage of such animal may be involved.

In that regard, the controller herein may be more broadly understood as a programmable controller and in electrical communication with a moving closing element (e.g. door, tailgate, window) and capable of instructing such moving closing element to stop moving or return to a safe position.

As may now be appreciated from the above, the present invention provides an anti-pinch system, apparatus and/or method that does not require a sensing element along the entire length of the tubing portions 12 or 14. The elastomeric tubing also does not need to be fully sealed. In addition, the invention herein avoids the issues that may otherwise arise where sensing elements that extend along the entirety of a given door perimeter must be positioned with relatively sharp corners that can lead to sensing failure over time.

1. An anti-pinching system comprising:
one or a plurality of unsealed elastomeric tubing portions; and
at least one pressure sensor in communication with said one or more elastomeric tubing portions where said pressure sensor is configured to detect a pressure rise of 10 pascals or less over a period of time of 2.0 milliseconds or less.

2. The anti-pinching system of claim 1 further including a controller in electrical communication with a moving closing element and capable of instructing said moving closing element to stop moving or return to an open position.

3. The anti-pinching system of claim 1 wherein said elastomeric tubing portion comprises one of ethylene-propylene diene monomer elastomer, polyurethane, polyester, polysiloxane, fluroelastomer or flurosilicon elastomer.

4. The anti-pinching system of claim 1 wherein said one or plurality of elastomeric tubing portions has a wall thickness in the range of 0.10 inches to 0.30 inches.

5. The anti-pinching system of claim 1 wherein said one or plurality of elastomeric tubing portions defines an unsealed cavity having a hydraulic diameter in the range of 0.1 inch to 1.0 inch.

6. The anti-pinching system of claim 1 wherein said one or plurality of elastomeric tubing portions has a length in the range of 30.0 inches to 50.0 inches.

7. An anti-pinching system for a vehicle door perimeter cavity configured to engage with a moving vehicle door, comprising:
one or a plurality of unsealed elastomeric tubing portions positioned between said moving vehicle door and vehicle door perimeter cavity; and
at least one pressure sensor in communication with said one or more elastomeric tubing portions where said pressure sensor is configured to detect a pressure rise of 10 pascals or less over a period of time of 2.0 milliseconds or less.

8. The anti-pinching system of claim 7 further including a controller in electrical communication with said moving vehicle door and capable of instructing said moving closing element to stop moving or return to an open position.

9. A method for detecting a pinch condition for a movable closing element that engages into a cavity for said closing element, comprising:
measuring within one or a plurality of unsealed elastomeric tubing portions positioned between said moving closing element and said cavity, a pressure rise of 10 pascals or less over a period of time of 2.0 milliseconds or less and identifying a pinch condition as a consequence of said pressure rise.
